(19) United States
(12) Patent Application Publication
(10) Pub. No.: US 2010/0025983 A1
(43) Pub. Date: Feb. 4, 2010

(54) Coupling Device for Connecting Line Devices, Preferably Quick Connector

(75) Inventors: Thomas Rösch, Linsengericht (DE); Bernhard Beck, Biebergemund (DE); Werner Hempel, Nidderau (DE)

Correspondence Address: BUCHANAN, INGERSOLL & ROONEY PC, POST OFFICE BOX 1404, ALEXANDRIA, VA, 22313-1404, US

(73) Assignee: Veritas AG, Gelnhausen (DE)

(21) Appl. No.: 11/992,318

(22) PCT Filed: Sep. 20, 2005
(86) PCT No.: PCT/EP2005/010141

§ 371 Date: Sep. 8, 2009

(51) Int. Cl. F16L 55/00

(52) U.S. Cl. 285/148.19

(57) ABSTRACT

The invention relates to a coupling device for connecting line devices, preferably quick connector, having a coupling housing comprising a connecting device that can be connected to an end section of a line device or of a second connecting device, and a valve body which can be transferred from a closed position to an open position when the end section of the line device or of the second connecting device is brought together with the coupling housing. The valve body can be actuated by means of a force deflecting device by bringing the end section of the line device or of the second connecting device together with the coupling housing.

The invention relates to a coupling device for connecting line devices, preferably quick connector, having a coupling housing comprising a connecting device that can be connected to an end section of a line device or of a second connecting device, and a valve body which can be transferred from a closed position to an open position when the end section of the line device or of the second connecting device is brought together with the coupling housing, according to the preamble of claim 1.

Various embodiments of such coupling devices are known from prior art inter alia as self-closing quick-fitting pipe unions for liquid and gas lines and are employed e.g. in automobile manufacture.

The DE 10048502 C1 shows a connection assembly with automatically closing leakage stop, consisting of a cylindrical reception housing with an opening for inserting a tubular plug-in piece, which is provided with a surrounding mounting collar which can be caught in a locking element arranged in the leading-in area of the reception housing. In the flow room of the reception housing, a valve body is moreover arranged by which the flow room is automatically closed and, when the plug-in piece is inserted, its front face presses it into an open position against the force of a coil spring.

The U.S. Pat. No. 5,485,982 A discloses a quick connector with a housing with a reception opening for inserting a line end piece with a circumferential mounting collar which can be caught within the reception opening of the housing by means of retainer springs and actuates a stop valve within the housing which permits flow into both directions after the line end piece has been inserted. Furthermore, the U.S. Pat. No. 5,485,982 A shows a quick connector which is designed as right angle plug connector and comprises a bent connection tube.

However, the function sections of such connectors, i.e. the connecting section and the valve section, have a rigid and linear design and require, in particular in the plug-in direction, considerable assembly space, which is mainly true for angled connectors.

In automotive industry, however, this often leads to problems in terms of constructive demands inter alia of modern engine and motor vehicle developments requiring ever more compact and space-saving constructions with the consequence of an increasing number of items being installed in the assembly sites, as it is on the one hand in some cases not possible to make quick connectors with a valve unit according to prior art which meet the constructive demands, and on the other hand the use of conventional quick connectors without a valve unit which can have a compact design and are combined with a valve unit which is disposed outside the quick connector and is then not automatically actuated when the line connection is unblocked, is not suited for reasons of work efficiency and security when they are used and assembled.

The object underlying the invention therefore is to provide a coupling device for connecting line devices, preferably quick connector, with a valve device according to the preamble of claim 1, which considers such constructive demands and permits an, in particular in the assembly direction, especially compact coupling device which, with respect to its geometry and design, can be flexibly adjusted to constructive requirements and mounting conditions.

This object is achieved according to the invention by a coupling device for connecting line devices, preferably quick connector, the valve body of which can be actuated by means of a force deflecting device by bringing the end section of the line device or of the second connecting device together with the coupling housing.

One advantage of the invention is the possibility of changing the flow direction within the section arranged between the coupling section and the valve section, permitting a particularly compact design of the connecting device. Furthermore, the construction according to the invention permits a particularly flexible adaptation of the coupling device to narrow and crooked mounting situations. Under such conditions, it is often advantageous that the coupling device according to the invention can have a particularly compact design in the connecting direction. Another advantage of the coupling device according to the invention is the possibility of spatially separating the coupling and blocking sites of the connecting and valve sections, which represents improved safety but can also be used for constructive optimization, for example, of the flow resistance, as the valve unit does not have to be accommodated following the connecting section and can thus be dislocated and made with a flow-enhancing design or be displaced to a less risked place. It would also be conceivable to make, by means of the geometric design of the coupling device or by the material selection, a coupling device with a dislocated valve unit, which, in the event of an accident or an engine compartment fire, carries out a deformation-conditioned or temperature-conditioned pipe-break and interrupts the fuel supply. Another advantage is that the coupling device according to the invention can be flexibly designed in a section between the connecting area and the valve area, which among others can considerably facilitate the installation.

Particularly advantageous is the use of such coupling devices in the automobile industry to unblock or interrupt the fuel flow when engines which are connected to fuel lines at the site of their production for a test run are again separated from fuel supply after the test run to transport them to the assembly line so that they can be mounted as intended and be connected there again to a fuel line, or to be able to remove the engine from the vehicle and to return it again in the course of maintenance, replacement or repair works without there being any leaking of fuel from the fuel line. Even if advantages and the use of the invention are in particular important and explained for automobile technology, the advantageous use of the invention is not restricted to this field and can also show its favorable properties in other fields of mechanical engineering, medical engineering, structural and domestic engineering and industry.

In a preferred embodiment of the coupling device according to the invention, the coupling housing can comprise a reception into which the end section of the line device can be inserted and in which this end section can be fixed in the inserted position, and the valve body is preferably automatically closing and can be transferred to the open position by means of the force deflecting device by inserting the end section of the line device, whereby a particularly compact embodiment practical for many mounting requirements where all movable components can be compactly brought together in the coupling device can be achieved.

In another preferred embodiment, the coupling housing can comprise an angled or bent flow channel. Thereby, the coupling device can be adapted to the structural conditions already in the manufacturing process and be equipped with a robust housing that can be easily manufactured.

In another preferred embodiment, the axis on the side of the connecting device and the axis of the coupling device on the side of the valve can be at an angle to each other, and the two axes can preferably include an angle of 90°. This geometry lends itself inter alia for typical right-angle connecting assemblies where the line device is to be guided e.g. closely along an object with an orientation perpendicular to the insertion direction or is to protrude into the mounting space as little as possible.

In another preferred embodiment, the coupling housing of the coupling device can contain a flexible section between the connecting section and the valve section, and the axis on the side of the connection device and the axis of the coupling device on the side of the valve can be pivoted and/or shifted with respect to each other. By such a construction, one can provide a coupling device of which the geometry is not rigid and which can be adapted to the mounting conditions and thus often facilitate the mounting of such a coupling or under certain conditions make it only possible then.

In a further preferred embodiment, the force deflecting device can comprise a pressure transmission device which permits reliable deflection and utilization of the insertion force for actuating the valve device which can be particularly easily realized mechanically and constructively.

In another preferred embodiment, the pressure transmission device can have a flexible design at least in portions, which makes it possible to achieve high flexibility in the deflection area for extreme turns and/or narrow radii of curvature, while inter alia in straight sections, for example in the valve and/or connecting area of the coupling device, rigid sections can be employed in the pressure transmission device.

In a further preferred embodiment, the pressure transmission device can be arranged in the lumen of the flow channel of the coupling housing and in the flow path between the connecting section for the end section of the line device or of the second connecting device and the valve body. Such an arrangement in many cases permits a constructively simple design as the pressure transmission device as a whole can be thereby accommodated within the flow channel, together with all valve components, and thus constructively complex passages and sealings of movable parts through/in the wall of the flow channel can be eliminated.

In a further preferred embodiment, the pressure transmission device can be hollow inside, such that a medium can flow through it, permitting a simple and flow-enhancing construction of the coupling device.

In a further preferred embodiment, the pressure transmission device can contain a thrust vectoring device which is flexible at least in sections. As a result, the construction of the pressure transmission device can be particularly well optimized as only in those areas where the force vector really is to be deflected, a thrust vectoring device adapted to the mechanical requirements can be employed in an otherwise e.g. rigid pressure transmission device.

In another preferred embodiment, the thrust vectoring device can comprise a metallic material, whereby typically good values with respect to incompressibility and thus pressure transmission can be achieved, while at the same time good flexibility properties—depending on the construction type—are obtained.

In another preferred embodiment, the thrust vectoring device can contain a plurality of wires or filaments, which represents a simple possibility of achieving the necessary flexibility of the thrust vectoring device.

In another preferred embodiment, the thrust vectoring device can comprise a glassy or ceramic material, whereby the design of the thrust vectoring device can be particularly incompressible and resistant to temperature and aggressive chemicals.

In another preferred embodiment, the thrust vectoring device can comprise a sliding and/or protective coating, whereby, for example, the sliding properties and/or media resistance can be clearly improved.

In another preferred embodiment, the thrust vectoring device can comprise a plurality of thrust piece elements in the axial direction which can be moved against each other, which considerably increases flexibility.

In another preferred embodiment, the thrust piece elements can be essentially annular or toroidal, or essentially spherical or ellipsoidal, and comprise at least one flow channel. Thereby, it is particularly easily possible to manufacture a thrust vectoring device comprising several thrust piece elements that can be moved against each other in the axial direction, which adapts to the curvature of the flow channel and comprises a low flow resistance.

In another preferred embodiment, the thrust vectoring device can comprise a polymeric material, preferably a thermoplastic, a thermoplastic elastomer, or an elastomer. This will make it in many applications possible to combine, thanks to the material properties of a suited polymeric material, flexibility and compression stiffness, and to achieve good medium resistance to the substances used in the field of employment and favorable sliding and wear properties and to manufacture a particularly inexpensive thrust vectoring device.

In another preferred embodiment, the pressure transmission device can be integrally formed with the thrust vectoring device, whereby efforts and costs of manufacture can be clearly reduced.

In another preferred embodiment, the thrust vectoring device can comprise stabilizing devices of a metallic or polymeric material, preferably of a metallic material, which are preferably intended for absorbing axial tensile and/or compressive strengths. With such a structure, e.g. the construction of a thrust vectoring device of a polymeric material can be further improved in that the employment properties are improved by combining e.g. a particularly flexible material, which determines the outer structure of the thrust vectoring device, with a second metallic or polymeric material having particular high tensile or compressive strength.

In another preferred embodiment, the stabilizing device can contain distance elements for pressure absorption and/or bending limitation. With such a construction, it is e.g. possible to use a particularly flexible or soft thrust vectoring device, which e.g. consists of a polymeric material and e.g. is stabilized against radial deformation by ring elements arranged e.g. at small distances from one another and which possibly simultaneously permits to limit the bending of the thrust vectoring device when the stabilizing devices contact each other on the inner side of the curvature.

In another preferred embodiment, the thrust vectoring device can comprise a helical spring-like element, preferably of a metallic or polymeric material, the coils of which are intended to support each other under pressure whereby a thrust vectoring device with a very simple construction can be realized.

In another preferred embodiment, the pressure transmission device can comprise, at least in sections, a flexible solid cylinder rigid with respect to thrust, the diameter of which is preferably smaller than the semidiameter of the flow channel, and which is surrounded by preferably three to eight supporting and stabilizing ribs circumferentially spaced apart from each other and in radial planes at equal distances. With such a construction, the mainly pressure-transmitting element can be arranged in the area of the center line of the flow channel, with only a small portion of the cross-sectional area of the flow channel being used, and this element can be stabilized by the supporting and stabilizing ribs and protected from radial deflection by evasive movements in case of force transmissions, wherein the space around the solid cylinder rigid with respect to thrust can be utilized for the flow.

In another preferred embodiment, the thrust vectoring device can comprise transversally guided recesses which preferably extend from a surface line or two surface lines situated diametrically oppositely to the center line and are preferably designed as V-shaped notches, whereby flexibility can be considerably increased. It is moreover possible, in case of preferably V-shaped notches arranged on the inner side of the curvature, to limit the radius of curvature in the minimum direction to the value predetermined by the abutment of the notch flanks formerly designed in V-shape.

In another preferred embodiment, the pressure transmission device can comprise supporting devices which can be supported against the inner wall of the flow channel of the coupling housing. This makes it possible to ensure stabilization of the pressure transmission device with respect to the center line of the flow channel and to reduce a deflection of the pressure deflecting device in case of the transmission of tensile and compressive strengths.

In another preferred embodiment, the supporting devices can comprise sliding elements, preferably sliding rings, surrounding the pressure transmission device, whereby the support of the pressure transmission device within the flow channel can be made particularly simple.

In another preferred embodiment, the supporting devices can comprise sliding sections, sliding distance sections or sliding guide sections which are formed to the pressure transmission device and can be moved against the inner wall of the flow channel of the coupling housing or special, in particular groove-like, sections of the same so as to slide, and which serve for friction reduction, spacing, path limitation and/or antitwist protection. Here, e.g. if a molded part, e.g. of a polymeric material, is used as pressure transmission device, it is possible to design this part in one piece and provide it with supporting devices in one manufacturing operation and to optimize these supporting devices to the effect that they either mainly reduce the slippage resistance of the pressure transmission device at the inner wall of the flow channel, and/or that they ensure an additional distance between the pressure transmission device and the inner wall of the flow channel. Such sections could at the same time also limit the axial travel of the pressure transmission device and/or, as antitwist protection, prevent a twisting of the pressure transmission device within the flow channel when these engage e.g. in groove sections within the flow channel.

In another preferred embodiment, the hollow section of the flow channel of the coupling housing which encloses the pressure transmission device can comprise at its inner wall sliding elements, sliding distance elements or sliding guide elements which can be moved against the pressure transmission device or against devices connected thereto, or special, in particular groove-like, sections of the same so as to slide and serve for friction reduction, spacing, path limitation and/or antitwist protection. Here, e.g. if a molded part, e.g. of a polymeric material, is used as pressure transmission device, it is possible to design this part in one piece and to provide it with sliding elements, sliding distance elements or sliding guide elements in one manufacturing operation and to optimize them to the effect that they either mainly reduce the slippage resistance of the pressure transmission device at the inner wall of the flow channel and/or create an additional distance between the pressure transmission device and the inner wall of the flow channel. Such elements can at the same time also limit the axial travel of the pressure transmission device and/or as antitwist protection prevent a twisting of the pressure transmission device within the flow channel when these engage e.g. in groove sections within the flow channel as sliding guide elements.

In a further preferred embodiment, the coupling device can comprise a stop device for the end section of the line device or of the second connecting device which can be moved against the end section of the line device or of the second connecting section and can be shifted, when the same is brought together with the coupling housing, and can be arranged, when the end section of the line device or of the second connecting device is connected with the coupling housing, between the end section of the line device or of the second connecting device and the pressure transmission device. By such a stop device, the construction of the contact area to the end section of the line device or of the second connecting device can advantageously be improved, and thus the force can be particularly securely and reliably transferred to the pressure transmission device, when the end section of the line device or of the second connecting device is brought together with the coupling housing, at the same time the pressure transmission device being protected from damage and wear.

In another preferred embodiment, the stop device can comprise an axial central opening which is preferably aligned with the opening of a hollow pressure transmission device, whereby in a simple manner a particularly flow-enhancing design can be obtained.

In another preferred embodiment, the stop device can comprise one to eight, preferably three or four, radially arranged ribs or bars which are distributed around the periphery at equal distances and can be supported at the inner wall of the coupling housing and/or guided in guiding devices of the inner wall of the coupling housing. With such an embodiment, it is possible to design the stop device so that the media can flow around it and to constructively provide a large flow cross-section at the same time. It is moreover possible to design the ribs or bars with respect to their shapes such that they can assume a supporting and/or guiding function. Furthermore, such a stop device can be adapted to a pressure transmission device having a similar cross-section with corresponding supporting and stabilizing ribs.

In another preferred embodiment, the thrust vectoring device can comprise resilient properties and be provided for exerting a restoring force on the valve body in its closing direction and to transfer the valve body, when the end section of the line device or of the second connecting device is removed from the connecting area of the coupling housing, from the open position into the closed position. This could be achieved, for example, by a thrust vectoring device consisting of a metallic or polymeric material of high elasticity, whereby it acts as spring element and leads to a restoring movement of the valve body, for example by suited contact areas within the flow channel against which the thrust vectoring device is supported, by the spring element's tendency to restore its original shape. It would thus be for example inter alia conceivable to design the thrust vectoring device as a leaf spring or coil spring or to integrate such a spring in the thrust vectoring device. Thereby, it can be constructively ensured that—independent of the pressure and flow ratios in the line devices connected to the coupling device—an immediate active closing of the valve device occurs and leakage does not happen, when the end section of the line device or of the second connecting device is removed. By the resilient design of the thrust vectoring device suggested herein, the aforementioned function can be ensured without the use of further components.

In another preferred embodiment, the coupling device can comprise a restoring device by which a restoring force acts on the valve body in its closing direction and which is provided for transferring the valve body from the open position into the closed position, when the end section of the line device or of the second connecting device is removed from the connecting area of the coupling housing. Here, an independent device or a component section which is not—or not preponderantly—simultaneously provided for pressure transmission, is responsible and optimized for the restoring function. This can constructively ensure in a particularly reliable manner that—independent of the pressure and flow ratios in the line devices connected to the coupling device—immediate automatic closing of the valve device occurs and leakage does not happen, when the end section of the line device or of the second connecting device is removed.

In another preferred embodiment, the restoring device can comprise a coil spring which results in a long restoring path and a particularly space-efficient installation while it can be simultaneously well positioned.

In another preferred embodiment, the coil spring can be arranged within the flow channel of the coupling housing and at least preponderantly in a section which is arranged in the flow channel between the connecting area of the coupling housing for the end section of the line device or of the second connecting device and the valve body, preferably in the closing direction of the valve body, in front of the valve body and adjacent to the same. This permits to arrange the coil spring between the connecting area and the valve area of the coupling device and to thus reduce the overall length.

In another preferred embodiment, the coil spring can be arranged within the flow channel of the coupling housing, enclosing at least sections of the pressure transmission device, between the inner wall of the coupling housing and the pressure transmission device. With such a construction, a particularly compact design can be achieved and at the same time the pressure spring can be also used as guide element for the pressure transmission device.

In another preferred embodiment, the coil spring can be a tension spring, resulting in a universal construction possibility for the restoration of the valve body, independent of the construction of the pressure transmission device.

In another preferred embodiment, the coil spring can be a pressure spring and clampable between a stop element mechanically connected to the pressure transmission device, and a support on the side of the housing which is axially spaced apart from the stop element and situated closer to the valve body in the flow direction with respect to this stop element, where the valve body can be transferred to the closing direction via the pressure transmission device by pulling, and the pressure spring can be loaded with pressure when the end section of the line device is brought together with the second connecting device with the coupling housing. This results in a particularly practical and constructively elegant solution for utilizing the pressure transmission device for actuating the valve body in both directions, i.e. in the opening direction and in the closing direction, where the pressure transmission device is employed as push-pull element.

In another preferred embodiment, the support of the pressure spring on the side of the housing can be arranged adjacent to the valve seat. As a result, the pressure spring can be arranged between the connecting section and the valve section directly adjacent to the valve seat and thus relocate it from the connecting section, whereby the coupling device is particularly compact in the insertion direction and the pressure transmission device can be stabilized at the same time.

In another preferred embodiment, the valve body can have a one-piece and rigid design, whereby it can be particularly easily manufactured and is very robust.

In another preferred embodiment, the valve body can consist of a polymeric, metallic, glassy or ceramic material, whereby the valve body can be adapted to the operational conditions within broad limits, corresponding to the constructive specifications.

In another preferred embodiment, the valve body can contain an essentially disk-shaped, conical, paraboloidal, pear-shaped or mushroom-shaped section which can be moved against the valve seat. By such a shaping, a good sealing effect of the valve body with respect to the valve seat can be achieved in a simple manner.

In another preferred embodiment, the valve body can comprise at least one ring seal, improving the tightness of the valve body towards the valve seat and ensuring more constructive freedom of designing the valve seat.

In another preferred embodiment, the valve body can comprise movable sector devices which comprise sealing edges or sealing surfaces by which in a closed state a sealing contact of the sector device to adjacent sealing edges or sealing surfaces can be created, where these sector devices can be removed from the center line in the radial direction at least in sections when the valve body is transferred to the open position and unblock a flow cross-section. With such an embodiment of the valve body it is possible to also design the valve body such that media can pass through and thus simultaneously achieve a flow around and through the valve body, whereby the flow resistance of the valve device is considerably reduced and the impairment of the flow channel and also vortex formation can be clearly reduced. Another advantage of the coupling device according to the invention is the straight passage through the valve device which is not obstructed by a valve body and thus offers better cleaning and sounding possibilities.

In another preferred embodiment, in the closed state a sealing contact can be created between the sealing edges or sealing surfaces of adjacent sector devices, and the sealing edges or sealing surfaces of adjacent sector devices which abut against each other in the closed state can circumferentially move away from each other at least in sections when the valve body is transferred to the open position. With such a structure of the valve body that can be technically easily realized, the section of the valve body on the side of the opening can maximally open.

In another preferred embodiment, the valve body with several sector devices can be, in the closed state, sealingly moved against an outer contour of the valve body with the valve seat, whereby at the time of the closing of the sealing edges or sealing surfaces of the sector devices, simultaneously a tight seat of the closed valve body in the valve seat can be achieved.

In another preferred embodiment, the valve body can be hollow, wherein in the closed state the valve body forms a hollow shape closed in the direction of one opening end, the hollow shape comprising an opening in the direction of a non-opening end of the valve body, and its sector devices can form sealing edges by which in the closed state a sealing contact between the sector devices can be created. Such a hollow design of the valve body permits to enlarge the flow cross-section and to thereby reduce flow resistance.

In another preferred embodiment, the sector devices can be movable in the axial direction relative to a valve seat, where the sector devices can be radially moved towards each other by pushing against the valve seat and can be closed, and can be opened by removing them from the valve seat. Such an embodiment permits in a simple and technically elegant manner to close the sector elements by shifting the same against the valve seat and to move the valve body against the valve seat in a sealing manner. This embodiment is also particularly advantageous for a coupling of the valve unit with the pressure transmission device.

In another preferred embodiment, the sector devices of the valve body can be closable by pulling the valve body into the valve seat, whereby the compound movement which brings the sealing edges of the sector devices into sealing contact and the valve body in sealing abutment with the valve seat, can be particularly simply and efficiently coupled with the movement of the force deflecting device.

In another preferred embodiment, the valve body can be connectable to the pressure transmission device by which the valve body can be moved relatively to the valve seat. In this embodiment, it is possible to directly couple the valve body and the pressure transmission device, which can be designed together in one piece or in several pieces, and to thus provide a simple and reliable construction.

In another preferred embodiment, the rotationally symmetric or polyhedral, axially symmetric valve body can comprise a transversal equatorial plane in which the transversal section thereof forms a surface maximum from which the valve body essentially conically tapers into the closing direction. By such a design of the valve body, the valve body itself can be simultaneously and without further means form a sealing cone and generate the radial closing force necessary for the closing movement of the sector devices when the valve body is pulled into the valve seat.

In another preferred embodiment, the valve body can comprise at least one basic element to which the sector devices are linked. This permits a simple and reliable construction of the linkage of the sector devices which can be individually connected to the basic element and are thus reliably held and guided.

In another preferred embodiment, the sector devices can be connected to the basic element of the valve body by means of hinges, preferably film hinges or bending sections, and the valve body can preferably have a one-piece design. Such a structural shape is particularly favorable as concerns construction and manufacture, and, in case of film hinges or bending sections, it possibly permits the manufacture of the whole valve body in only one manufacturing step, e.g. by injection molding.

In another preferred embodiment, the valve body can comprise different materials by sections and preferably be manufactured in a multi-component forming method. This can be done in particular by multi-injection molding, multi-injection/compression molding, or by corresponding sintering methods, coextrusion, coating or lamination methods. Thereby, the valve body can be optimally adapted inter alia to the different mechanical requirements of the various function sections, whereby such a valve body is in particular suited for increased demands. It is thus for example also conceivable to provide the valve body with gliding or abrasion-resistant coatings or bending-resistant laminations, or to equip movable or sealing sections with materials particularly suited for fulfilling the specific requirements.

In another preferred embodiment, the valve body can comprise, in the linkage and bending area of the sector devices, a material of higher elasticity and/or lower modulus of elasticity compared to areas of the valve body adjacent thereto, whereby this area can be particularly adapted to the bending stress when the valve is being actuated.

In another preferred embodiment, the valve body can comprise a sealing material in the area of the sealing edges of the sector devices. In this manner, for example particularly reliably sealing, adaptable, flexible, and/or wear-resistant sealing areas that are mediophobe with respect to the media flowing through the valve area can be created between the sector devices.

In another preferred embodiment, the valve body can comprise a sealing material in the area of the valve seat of the sector devices. In this manner, for example a particularly reliably sealing, adaptable, flexible, and/or wear-resistant sealing area that is mediophobe with respect to the media flowing through the valve area can be created between the valve body and the valve seat.

In another preferred embodiment, the sector devices can be prestressed in the open position, whereby a reliable and maximal opening of the sector devices and thus the unblocking of the complete flow cross-section can be ensured, independent of pressure and flow ratios on both sides of the valve device.

In another preferred embodiment, the bending sections can preferably have a three-dimensional shape, where the material elasticity can be utilized for prestressing the sector devices. By such an embodiment, the provision of the prestress is possible without any additional efforts as concerns the manufacture, only with the aid of material properties and design.

In another preferred embodiment, the valve body can be surrounded by a protective sleeve in the radial direction, this sleeve preferably surrounding the valve body in the radial direction essentially completely, at least in its closed state. With such a protective sleeve which can be formed in one piece with the housing, integrated in the line device following on the side of the valve, or be formed separately and connected to the housing so that it can be removed e.g. for maintenance works, it is possible to protect the valve body from damages during assembly or in use.

In another preferred embodiment, the protective sleeve can be captively connectable to the coupling housing, and preferably be formed in one piece with the same. Here, losing and possibly also unintentional loosening of the protective sleeve during assembly and use can be reliably prevented. This can be done by suited mechanical provisions, or—if a removal of the protective sleeve e.g. in case of assembly and maintenance works is not necessary in a cheaper and simpler manner—by a material connection between the protective sleeve and the coupling housing, which can be cheapest done by a one-piece design of both aforementioned devices.

The above mentioned embodiments of the invention only represent a selection of practical possibilities of designing the subject matter of the invention, which are given in the individual subclaims. These special designing possibilities can be used individually or, if this is technically possible and makes sense, also in combination of several of the aforementioned designing variants with one coupling device according to claim 1, as can be taken from the corresponding relations of the depending claims.

Below, the invention will be illustrated more in detail by way of example with reference to a selection of preferred embodiments in connection with the associated figures. In the drawings:

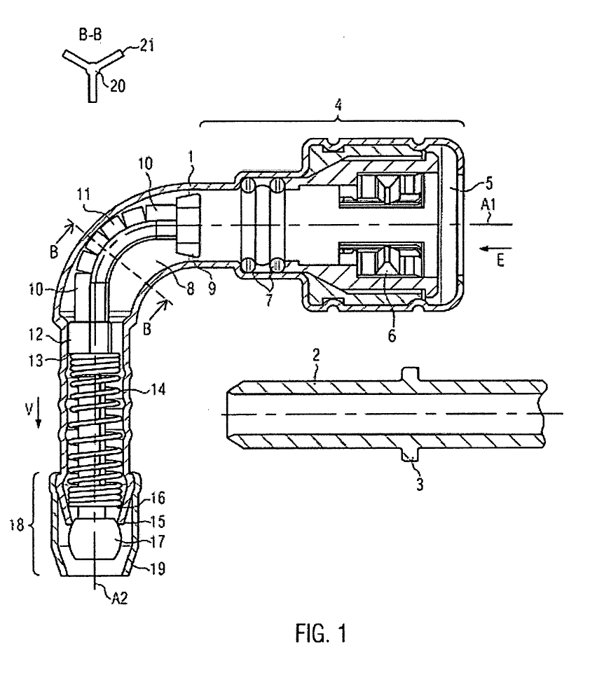

FIG. 1 shows the schematic representation of a median section in an axial plane through a quick connector according to a first embodiment with uncoupled line muff and closed valve;

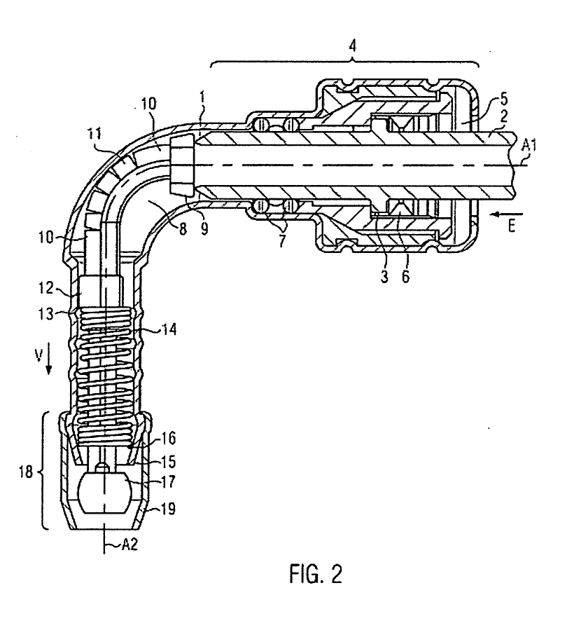

FIG. 2 shows the schematic representation of a median section in an axial plane through a quick connector according to a first embodiment with inserted line muff and opened valve;

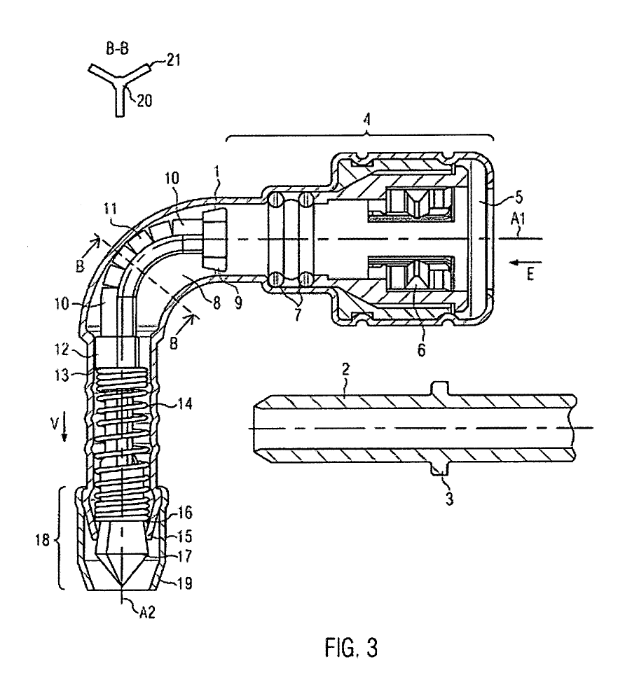

FIG. 3 shows the schematic representation of a median section in an axial plane through a quick connector according to a second embodiment with uncoupled line muff and closed valve;

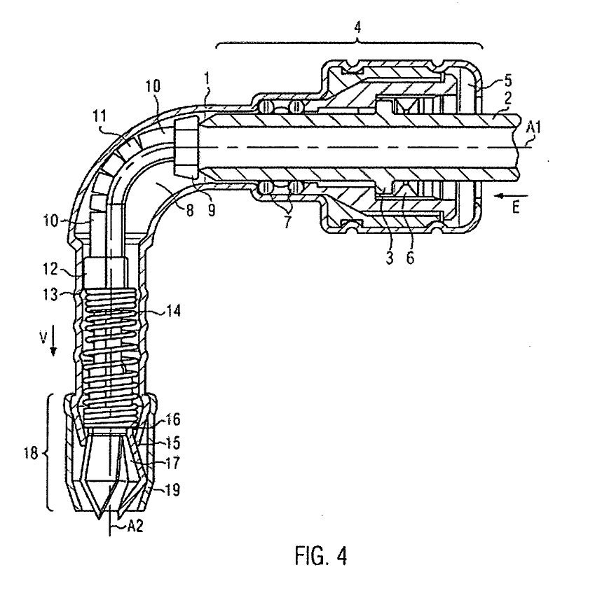

FIG. 4 shows the schematic representation of a median section in an axial plane through a quick connector according to a second embodiment with inserted line muff and opened valve;

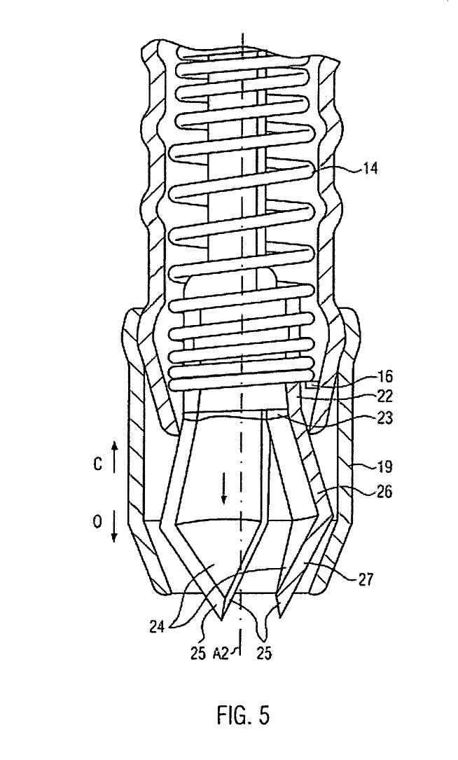

FIG. 5 shows the schematic detailed representation of a median section in an axial plane through the valve area of a quick connector according to a second embodiment with inserted line muff and opened valve.

FIG. 1 shows a quick connector or a quick-fitting pipe union according to a first embodiment having a coupling housing 1 for connecting a line end section or a line end muff 2 with a circumferentially extending mounting collar 3 where the line end piece 2 is uncoupled and the valve is in the closed position.

The coupling housing 1 comprises a straight axial section, the insertion axis A1, which comprises the connecting section 4 on the side of the connecting end, in the insertion direction E followed by a bent section describing a bend of 90°, and which passes over again in a straight axial section on the side of the valve, the valve axis A2, and ends in the valve section 18. The coupling housing 1 is hollow and a flow channel 8 passes through it which is closed in the valve area (valve section 18) by the valve body 17 in the closed position.

The connecting section 4 of the coupling housing 1 comprises a reception opening 5 for axially inserting (in the direction E) the line muff 2 of a line and with a connecting device 6, by which the line muff 2 can be locked, as well as washers 7 arranged behind it in the insertion direction E, by means of which the mechanically locked line muff 2 can be hydraulically or pneumatically connected to the flow channel 8 and sealed towards the surrounding area liquid-tightly and/or gas-tightly.

At the end of the connecting section 4 on the side of the valve and at the end opposite to the reception opening 5, a stop ring 9 through which media can pass in the axial direction is arranged and connected with a pressure transmission device 10 designed as a pressure plunger. The pressure transmission device 10 designed as a plunger is in this case formed of flexible, medium-resistant plastics and possesses a flexible plunger section 11 in a section adjacent to the stop ring 9 for thrust vectoring. This flexible plunger section 11 comprises, for increasing flexibility, transversally guided recesses on the outer side of the curvature which extend from the surface line on the outer side of the curvature towards the center line of the plunger. The plunger 10 itself in this embodiment shows a three-wing profile in the transversal cutting plane B-B, consisting of a central thrust cylinder 20 of a small diameter which is surrounded by three supporting and stabilizing ribs 21 circumferentially arranged in radial planes and at equal distances and rotated by 120° each in the transversal cutting plane.

In the direction V on the side of the valve end, a rigid section of the plunger 10 follows the flexible plunger section 11, the rigid section bearing a supporting device 12 which is on the one hand supported at the inner wall of the housing of the flow channel 8 and thus stabilizes the plunger 10, and on the other hand simultaneously serves as stop element 13 for a pressure spring 14.

The pressure spring 14 is clamped between the aforementioned stop element 13 and a support 16 arranged adjacent to the valve seat 15 on the side of the housing and serves as restoring device retracting the valve body 17 into the valve seat 15 and thus closing the valve when the line muff 2 is uncoupled.

Furthermore, the drawing shows a protective sleeve 19 which encloses the valve section 18 and thus protects the valve device from damage during assembly and in operation.

FIG. 2 shows the same embodiment as FIG. 1, however with inserted line muff 2 and opened valve. Thus, the embodiment in FIG. 2 corresponds, with respect to its components, to FIG. 1, so that only differences are discussed to avoid repetitions.

FIG. 2 shows the line muff 2 in a locked position within the connecting section 4 of the coupling housing 1, where connecting devices 6 grip behind the mounting collar 3 of the line muff 2 and thus lock the same. By inserting the line muff 2, the stop device 9 was pushed forward in direction E, the insertion direction of the line muff 2, in comparison to the state represented in FIG. 1, and the pressure was transmitted to the plunger 10 and the same was pushed further in the valve direction V. This movement leads to a compression of the pressure spring 14 due to the movement of the stop element 13 towards the support 16 on the side of the housing, the pressure spring being clamped between the stop element 13 and the support 16 on the side of the housing. At the same time, the valve body 17 connected to the pressure transmission device 10 is lifted from the valve seat 15, whereby the flow channel 8 is opened at the valve and a medium can flow through.

When the connecting device 6 is released and the line muff 2 is removed, the restoring force of the pressure spring 14 results in a reversal of the operations with a contradirectional movement of the pressure transmission device 10 which pulls back the valve body 17 into the valve seat 15, while the pressure transmission device 10 and the stop device 9 return to the position shown in FIG. 1.

FIG. 3 and FIG. 4 show schematic representations corresponding to FIGS. 1 and 2 of a median section in an axial plane through a quick connector with uncoupled line muff and closed valve (FIG. 3), and schematic representations of a median section in an axial plane through a quick connector with inserted line muff and opened valve (FIG. 4) according to a second embodiment of the invention; FIG. 5 shows a representation of a detail of FIG. 4 of the valve section in an opened position and illustrates more in detail the function of the valve unit with the valve body through which media can flow. This second embodiment in essentially points corresponds to the first embodiment, where reference numerals as well as statements of the first embodiment also apply to the second embodiment. To avoid repetitions, only differences and particularities of the second embodiment are discussed.

The second embodiment differs from the first embodiment by the construction of the valve unit. It consists, instead of a one-piece rigid valve body 17, of a hollow valve body 17 through which media can flow and which is in the represented manner at its cylindrical basic element 22 with three section devices 24 linked thereto which in the closed state have the shape of a truncated cone 26 which sits with the pointed end on the cylindrical basic element 22 and is connected at its unpointed end to a cone 27 having the same base which is inversely arranged, i.e. mirrored at the base of the cone. The outer shape formed by the sector devices 24 in the closed state is referred to as double-cone structure 26, 27 below. This double cone structure 26, 27 is divided into three double cone structure sectors or sector devices 24 connected to the basic element 22 via bending sections 23 by three radial planes situated at an angle of 120° with respect to each other and starting from the center line A2. These sector devices 24 form sealing edges 25 towards the respective adjacent sector device 24 in the closed state. Moreover, the double cone structure 26, 27 of the closed valve body 17 can be moved by pulling the plunger 10 connected to the valve body into the valve seat, where the cone formed by the truncated cone section 26 of this double cone structure 26, 27 also provides a sealing contact with the valve seat 15.

By lifting this double cone structure 26, 27 from the valve seat 15, the bending sections 23 prestressed due to their three-dimensional structure automatically open and unblock the cross-section of flow.

By its design, the truncated cone section 26 of the double cone structure 26, 27 linked to the basic element 22 forms a cone by which a radial force can act on the double cone structure 26, 27 by pulling into the valve seat 15 and it can be tightly closed, where at the same time a tight seat of the double cone structure 26, 27 in the valve seat 15 is provided.

Such a valve construction permits to make a valve with a straight passage and a particularly low flow resistance.

Further variants to the aforementioned embodiments are possible and make sense. The most important ones of them are represented by way of example below with brief explanations:

The coupling housing 1 of the coupling device can contain, instead of a section already being bent in the manufacturing process, a bendable or flexible section which can be manufactured, for example, as joint section or by a flexible section, e.g. similar to a corrugated pipe. The coupling housing 1 is here preferably made of a polymeric or metallic material which inter alia is selected so as to be adapted to the conditions of employment (temperature, mechanical stresses) and medium-resistance.

For force transmission and deflection, too, a plurality of possibilities is conceivable. Thus, the claims already give a plurality of materials and embodiments for the pressure transmission device 10. In particular, the variants already given in the claims using polymeric or metallic materials or a corresponding hybrid construction lend themselves. It is also conceivable to design, instead of a plunger 10 with flexible plunger section, at least in the thrust vectoring area, the thrust vectoring device 11 in the axial direction by several thrust piece elements which can be moved against each other, which are e.g. essentially annular or toroidal or essentially spherical or ellipsoidal and comprise at least one flow channel 8 and/or bear ribs arranged in the circumferential area around which media can flow and thus transmit the compressive force introduced when the line muff 2 is inserted to the valve device without closing the flow channel 8. By sliding and/or protective coatings, the range of application for materials reasonable for the pressure transmission device 10 can be increased by improving in particular medium resistance and sliding properties.

Apart from the three-wing plunger construction of flexible medium-resistant plastics mentioned in the first embodiment, the pressure transmission device 10 can, depending on the requirements of application and specifications, also comprise a tubular element through which media can flow internally, e.g. a plastic tube, which can furthermore optionally comprise transversally guided recesses for increasing flexibility which preferably extend from a surface line or two diametrically opposed surface lines towards the center line and are preferably designed as V-shaped notches, which can considerably increase flexibility. In case of V-shaped notches provided on the inner side of the curvature, such a construction can at the same time limit the bend radius in the minimum direction by the notch flanks of the V-shaped sections limiting the bending of the flexible plunger section to the radius of curvature where the notch flanks contact each other. As another alternative embodiment for the use as pressure transmission device 10, a coil spring-like element, preferably of a metallic or polymeric material, would also be conceivable which can have very high flexibility and simultaneously effectively transmit the compressive force if its windings support each other under pressure. Such a coil spring-like element can here function alone as pressure transmission device 10 or in connection with, for example, an internally situated, e.g. tubular or shaped plunger element.

It would also be possible to provide a tubular element e.g. acting as pressure transmission device 10 for stabilizing distance elements e.g. in the form of metallic rings spaced apart which stabilize these tubular elements and which can limit the bend to the bend radius at which the metallic rings abut against each other on the inner side of the curvature in a similar manner as the aforementioned V-shaped recesses.

For certain applications it can be reasonable to stabilize the pressure transmission device 10 within the flow channel 8 by supporting devices which are supported against the inner wall of the flow channel 8 of the coupling housing 1 to prevent evasive movements of the pressure transmission device 10, e.g. when pressure is exerted. Here, e.g. sliding elements, such as sliding rings which can be shifted onto the pressure transmission device, would be conceivable. It is also possible to either provide the pressure transmission device 10 or the inner wall of the hollow section of the flow channel 8 of the coupling housing 1 enclosing the pressure transmission device 10 with sliding elements, sliding distance elements or sliding guide elements, whereby a friction reduction, spacer function, path limitation and/or antitwist protection can be achieved. Such sections can be designed e.g. as continuous or interrupted ribs or wings extending in the axial direction and also guided along in complementary grooves provided for this purpose at the respective other component.

The aforementioned stop ring 9 is not obligatory in each case, it is, however, in most cases advantageous and serves wear protection and secure pressure transmission between the line muff 2 and the pressure transmission device 10. In the process, the stop element 9 should form a contact to the line muff as secure as possible and simultaneously impair the flow path from the line muff 2 in the flow channel 8 as little as possible. Advantageously, the stop element 9 is also adapted to the construction of the pressure transmission device 10. That means that in case of the above described three-wing plunger, a stop device 9 which is also provided with three radial wings or ribs and circumferentially comprises a cylindrical stabilization section could also make sense. In case of a hollow pressure transmission device 10 through which media can flow, it can in contrast be advantageous to provide the stop device 9 with a large axial central opening which is aligned with the hollow pressure transmission device 10. Similar to the pressure transmission device 10, the stop device 9 can also be additionally provided with sliding and/or guide sections at the outer circumference.

In another variant of the coupling device, it can be reasonable to replace the pressure spring 14 by a tension spring, e.g. if the pressure transmission device 10 is exclusively provided for pressure transmission or is unsuited for the transmission of tensile forces and can therefore not be used or should not be used for pulling back the valve body 17 into the valve seat 15.

In the other variant of the coupling device, the coupling device does not end in a (terminal) valve section 18, but the valve device is arranged in the middle of a longer line device.

For certain other requirements of application, a variant of the coupling device can be reasonable where the valve device is spatially separated from the connecting section 4 at a great distance. It would thus e.g. be conceivable to equip a fuel line with such a coupling device where the blocking site is relocated from the engine compartment and arranged on the side of the tank, whereby security advantages in the event of an accident or engine compartment fire as well as spatial advantages for the construction of the valve unit can arise. With respect to the above mentioned safety aspect, it would be conceivable to manufacture a coupling device with relocated valve unit by the geometric design of the coupling device and the line extension or the material selection and possibly also break-off areas, which coupling device in the event of an accident or an engine compartment fire automatically closes as a consequence of deformation or temperature and thus interrupts the fuel supply.

Also relating to the construction and embodiment of the valve body 17 of the second embodiment, further variants are possible and reasonable, the most important ones of which will be represented below by way of example with brief illustrations:

Instead of a hollow valve body 17, as represented in the above embodiment, it can be reasonable or necessary e.g. for the employment in high-pressure blocking devices, to equip the valve body 17 with massive sector devices 24 e.g. of a metallic material, so that in the closed state, a large-surface tight closing between the sector devices 24 can be achieved and a high edge load of the sealing edges 25, as it occurs in case of a hollow sealing body 17, is avoided.

Also with respect to the geometric design of the valve body 17, various variants are conceivable depending on the purpose of the application and construction type of the valve. Thus, it can be advantageous to provide the valve body 17 with a polyhedral structure, e.g. to fix the same by means of straight hinge elements 23 to the basic body 22 of the valve unit, for which in particular a bipyramidal structure of two three-dimensional simplexes or tetraeders with equal bases is recommendable, as here the sector devices 24 comprise the best self-centering properties and the number of hinges 23 is reduced. Moreover, such a valve body 17 is simultaneously adjusted or oriented in the (polygonal) valve seat 15 in the rotational direction (syngonal).

In view of the sealing properties of the contact area between the valve seat 15 and the valve body 17, in contrast in the transversal cutting plane a circular contact is advantageous. This can be achieved by a valve body 17 with double cone structure 26, 27 or by the passing of the valve body 17 in the axial direction in the transversal cutting plane from a polygonal cross-section (in the area of the hinge) to a circular cross-section (in the area of the sealing seat 15 of the valve body 17 in the valve seat 15). Such a valve body 17 which can be made e.g. of a polymeric material with an injection molding method in one piece together with the basic element of the valve body 22 can in this case be equipped with film hinges or bending sections 23 and already prestressed in the manufacturing process which opens the valve body 17 and thus prevents the sector devices 24 from remaining in a closed position after the valve body 15 has been lifted from the valve seat 15.

In some applications, it can also be reasonable to provide the valve body 17 in the median cutting plane not with a linear-conical extension, but with a different curve extension, whereby for example bodies of revolution having a different shape can result, with a geometry which does not have a double-conical structure with e.g. ellipsoidal, paraboloidal or hyperboloidal partial surfaces. Such a design lends itself e.g. to perform a valve opening or valve closing, respectively with a short lifting movement of the pull-press actuating device, to increase the closing forces of the sector devices 24, or to facilitate, aggravate or prevent the reopening of the valve—depending on the design of the contact angle between the valve body 17 and the valve seat 15. Moreover, by such a design of the valve body 17, opening angle and flow cross-section can be optimized by the opened valve body 17.

As further variant, it is also conceivable not to connect the sector devices 24 with a basic element 22, but e.g. to directly link it to the inner wall of the flow channel 8 or at the actuating device to thus eliminate the basic element 22 or to increase the flexibility of the sector devices 24.

1. Coupling device for connecting line devices, having a coupling housing comprising a connecting device that can be connected to an end section of a line device or of a second connecting device, and a valve body which can be transferred from a closed position to an open position when the end section of the line device or of the second connecting device is brought together with the coupling housing, wherein the valve body can be actuated by means of a force deflecting device by bringing the end section of the line device or of the second connecting device together with the coupling housing, wherein the coupling housing of the coupling device contains a flexible section between a connecting section and a valve section, and an axis on the side of the connecting device and an axis on the side of the valve of the coupling device can be pivoted and/or shifted with respect to each other.

2. Coupling device for connecting line devices according to claim 1, wherein the coupling housing comprises a reception into which the end section of the line device can be inserted and in which this end section can be fixed in the inserted position, and the valve body is preferably automatically closing and can be transferred to the open position by means of the force deflecting device by introducing the line device.

3. Coupling device for connecting line devices according to claim 1, wherein the coupling housing comprises an angled or bent flow channel.

4. Coupling device for connecting line devices according to claim 1, wherein the coupling device's axis on the side of the connecting device, and the axis on the side of the valve are at an angle to each other and that the two axes preferably include an angle of 90°.

5. Coupling device for connecting line devices according to claim 1, wherein the force deflecting device comprises a pressure transmission device.

6. Coupling device for connecting line devices according to claim 1, wherein the pressure transmission device is flexible at least in sections.

7. Coupling device for connecting line devices according to claim 1, wherein the pressure transmission device is arranged in the lumen of the flow channel of the coupling housing and in the flow path between the connecting section for the end section of the line device or of the second connecting device and the valve body.

8. Coupling device for connecting line devices according to claim 1, wherein the pressure transmission device is such that it is hollow inside and media can flow through it.

9. Coupling device for connecting line devices according to claim 1, wherein the pressure transmission device contains a thrust vectoring device which is flexible at least in sections.

10. Coupling device for connecting line devices according to claim 9, wherein the thrust vectoring device comprises a metallic material.

11. Coupling device for connecting line devices according to claim 9, wherein the thrust vectoring device contains a plurality of wires or filaments.

12. Coupling device for connecting line devices according to claim 9, wherein the thrust vectoring device comprises a glassy or ceramic material.

13. Coupling device for connecting line devices according to claim 9, wherein the thrust vectoring device comprises a sliding and/or protective coating.

14. Coupling device for connecting line devices according to claim 9, wherein the thrust vectoring device comprises in the axial direction a plurality of thrust piece elements which can be moved against each other.

15. Coupling device for connecting line devices according to claim 14, wherein the thrust piece elements are essentially annular or toroidal or essentially spherical or ellipsoidal and comprise at least one flow channel and/or ribs arranged in the circumferential area around which media can flow.

16. Coupling device for connecting line devices according to claim 9, wherein the thrust vectoring device comprises a polymeric material, preferably a thermoplastic, a thermoplastic elastomer, or an elastomer.

17. Coupling device for connecting line devices according to claim 9, wherein the pressure transmission device is formed in one piece with the thrust vectoring device.

18. Coupling device for connecting line devices according to claim 9, wherein the thrust vectoring device comprises stabilizing devices of a metallic or polymeric material, preferably of a metallic material, which are preferably intended for absorbing axial tensile and/or compressive forces.

19. Coupling device for connecting line devices according to claim 18, wherein the stabilizing devices contain distance elements for absorbing pressure and/or limiting bending.

20. Coupling device for connecting line devices according to claim 9, wherein the thrust vectoring device comprises a coil spring-like element, preferably of a metallic or polymeric material, the windings of which are intended to support each other under pressure.

21. Coupling device for connecting line devices according to claim 5, wherein the pressure transmission device comprises a solid cylinder flexible at least in sections and rigid with respect to thrust, the diameter of which is preferably smaller than the semidiameter of the flow channel, and which is surrounded by preferably three to eight supporting and stabilizing ribs circumferentially spaced apart from each other and in radial planes at equal distances.

22. Coupling device for connecting claim 5, wherein at least one of the preceding claims, characterized in that the pressure transmission device comprises transversally guided recesses which preferably extend from a surface line or two surface lines diametrically opposed to one another to the center line and are preferably designed as V-shaped notches.

23. Coupling device for connecting line devices according to claim 5, wherein the pressure transmission device comprises supporting devices which can be supported against the inner wall of the flow channel of the coupling housing.

24. Coupling device for connecting line devices according to claim 23, wherein the supporting devices comprise sliding elements, preferably sliding rings, which surround the pressure transmission device.

25. Coupling device for connecting line devices according to claim 23, wherein the supporting devices comprise sliding sections, sliding distance sections or sliding guide sections which are formed to the pressure transmission device and can be moved against the inner wall of the flow channel of the coupling housing or special, in particular groove-like, sections of the same so as to slide, and which serve for friction reduction, spacing, path limitation and/or antitwist protection.

26. Coupling device for connecting line devices according to claim 25, wherein the hollow section of the flow channel of the coupling housing surrounding the pressure transmission device comprises, at its inner wall, sliding elements, sliding distance elements or sliding guide elements, which can be moved against the pressure transmission device or devices connected thereto or special, in particular groove-like, sections of the same so as to slide, and which serve for friction reduction, spacing, path limitation and/or antitwist protection.

27. Coupling device for connecting line devices according to claim 5, wherein the coupling device comprises a stop device for the end section of the line device or of the second connecting device, which can be moved against the end section of the line device or of the second connecting device when the same is brought together with the coupling housing and which is movable, and which is, when the end section of the line device or of the second connecting device is connected to the coupling housing, arranged between the end section of the line device or of the second connecting device and the pressure transmission device.

28. Coupling device for connecting line devices according to claim 27, wherein the stop device comprises an axial central opening which is preferably arranged in alignment with the opening of a hollow pressure transmission device.

29. Coupling device for connecting line devices according to claim 27, wherein the stop device comprises one to eight, preferably three or four, radially arranged ribs or bars which are distributed around the circumference at equal distances and can be supported at the inner wall of the coupling housing and/or guided in guiding devices of the inner wall of the coupling housing.

30. Coupling device for connecting line devices according to claim 9, wherein the thrust vectoring device comprises resilient properties and is provided for exerting a restoring force on the valve body in the closing direction of the same and for transferring the valve body, when the end section of the line device or of the second connecting device is removed from the connecting device of the coupling housing, from the open position into the closed position.

31. Coupling device for connecting line devices according to claim 1, wherein the coupling device comprises a restoring device which exerts a restoring force on the valve body in the closing direction of the same and is provided for transferring the valve body, when the end section of the line device or of the second connecting device is removed from the connecting area of the coupling housing, from the open position into the closed position.

32. Coupling device for connecting line devices according to claim 31, wherein the restoring device comprises a coil spring.

33. Coupling device for connecting line devices according to claim 32, wherein the coil spring is arranged within the flow channel of the coupling housing and at least preponderantly in a section which is arranged in the flow channel between the connecting area of the coupling housing for the end section of the line device or of the second connecting device and the valve body, preferably in the closing direction of the valve body, in front of the valve body and adjacent to the same.

34. Coupling device for connecting line devices according to claim 32, wherein the coil spring is arranged within the flow channel of the coupling housing, enclosing at least sections of the pressure transmission device, between the inner wall of the coupling housing and the pressure transmission device.

35. Coupling device for connecting line devices according to claim 32, wherein the coil spring is a tension spring.

36. Coupling device for connecting line devices according to claim 32, wherein the coil spring is a pressure spring and can be clamped between a stop element mechanically connected to the pressure transmission device and a support on the side of the housing at an axial distance thereto and with respect to this stop element closer to the valve body in the flow direction, wherein the valve body can be transferred to the closed position via the pressure transmission device by pulling, and the pressure spring can be loaded with pressure when the end section of the line device or of the second connecting device is brought together with the coupling housing.

37. Coupling device for connecting line devices according to claim 36, wherein the support of the pressure spring on the side of the housing is arranged adjacent to the valve seat.

38. Coupling device for connecting line devices according to claim 1, wherein the valve body has a one-piece and rigid design.

39. Coupling device for connecting line devices according to claim 1, wherein the valve body consists of a polymeric, metallic, glassy or ceramic material.

40. Coupling device for connecting line devices according to claim 1, wherein the valve body contains an essentially disk-shaped, conical, paraboloidal, pear-shaped or mushroom-shaped section which can be moved against the valve seat.

41. Coupling device for connecting line devices according to claim 1, wherein the valve body comprises at least one ring sealing.

42. Coupling device for connecting line devices according to claim 1, wherein the valve body comprises movable sector devices which comprise sealing edges or sealing surfaces by which, in a closed state, a sealing contact of the sector device to adjacent sealing edges or sealing surfaces can be created, and these sector devices can be removed from the center axis in the radial direction at least in sections when the valve body is transferred to the open position and unblock a flow cross-section.

43. Coupling device for connecting line devices according to claim 42, wherein, in the closed state, a sealing contact between the sealing edges or sealing surfaces of adjacent sector devices can be created, and the sealing edges or sealing surfaces of adjacent sector devices abutting each other in a closed state at least in sections circumferentially move away from each other when the valve body is transferred to the open position.

44. Coupling device for connecting line devices according to claim 42, wherein t the valve body with several sector devices can be moved against an outer contour of the valve body with the valve seat in the closed state.

45. Coupling device for connecting line devices according to claim 42, wherein the valve body is hollow, wherein the valve body in the closed state forms a hollow shape closed in the direction of an opening end (0), the hollow shape comprising an opening in the direction of a non-opening end of the valve body, and the sector devices of which form sealing edges by which a sealing contact can be created between the sector devices in the closed state.

46. Coupling device for connecting line devices according to claim 42, wherein the sector devices can be moved relative to a valve seat into the axial direction, wherein the sector devices can be radially moved towards each other and closed by shifting them against the valve seat and can be opened by removing them from the valve seat.

47. Coupling device for connecting line devices according to claim 46, wherein the sector devices of the valve body can be closed by pulling the valve body into the valve seat.

48. Coupling device for connecting line devices according to claim 46, wherein the valve body can be connected to the pressure transmission device by which the valve body can be moved relative to the valve seat.

49. Coupling device for connecting line devices according to claim 1, wherein the rotationally symmetric or polyhedral, axially symmetric valve body comprises a transversal equatorial plane in which its transversal section forms a surface maximum from which the valve body essentially conically tapers in the closing direction.

50. Coupling device for connecting line devices according to claim 42, wherein the valve body comprises at least one basic element which the sector devices are linked.

51. Coupling device for connecting line devices according to claim 50, wherein the sector devices are connected to the basic element of the valve body by means of hinges, preferably film hinges, or bending sections, and the valve body is preferably formed in one piece.

52. Coupling device for connecting line devices according to claim 1, wherein the valve body comprises different materials by sections and can be preferably manufactured in a multi-component forming method.

53. Coupling device for connecting line devices according to claim 42, wherein the valve body comprises a material of higher elasticity and/or lower modulus of elasticity in the linkage and bending area of the sector devices, compared to the adjacent areas of the valve body.

54. Coupling device for connecting line devices according to claim 42, wherein the valve body comprises a sealing material in the area of the sealing edges of the sector devices.

55. Coupling device for connecting line devices according to claim 42, wherein the valve body comprises a sealing material in the area of the valve seat of the sector devices.

56. Coupling device for connecting line devices according to claim 42, wherein the sector devices are prestressed in the open position.

57. Coupling device for connecting line devices according to claim 42, wherein the bending sections preferably have a three-dimensional shape, wherein the material elasticity can be utilized for prestressing the sector devices.

58. Coupling device for connecting line devices according to claim 1, wherein the valve body is surrounded in the radial direction by a protective sleeve, this sleeve preferably essentially completely surrounding the valve body at least in its closed state in the radial direction.

59. Coupling device for connecting line devices according to claim 58, wherein the protective sleeve can be captively connected to the coupling housing and is preferably formed in one piece with the same.

60. The coupling device of claim 1, wherein the coupling device is a quick connector.
